(19) United States
(12) Patent Application Publication
(10) Pub. No.: US 2019/0280365 A1
(43) Pub. Date: Sep. 12, 2019

(54) VEHICLE INTEGRATED ANTENNA WITH ENHANCED BEAM STEERING

(71) Applicant: GM GLOBAL TECHNOLOGY OPERATIONS LLC, DETROIT, MI (US)

(72) Inventors: HYOK JAE SONG, OAK PARK, CA (US); JAMES H. SCHAFFNER, CHATSWORTH, CA (US); Timothy J. Talty, BEVERLY HILLS, MI (US); Duane S. Carper, DAVISON, MI (US); Eray Yasan, CANTON, MI (US)

(21) Appl. No.: 15/914,266

(22) Filed: Mar. 7, 2018

(51) Int. Cl. H01Q 1/12; H01Q 3/26; H01Q 5/30

(52) U.S. Cl. CPC H01Q 1/1271; H01Q 5/49; H01Q 5/30; H01Q 3/2682

(57) ABSTRACT

The present application generally relates to antennas embedded in or on glass structures. More specifically, the application teaches an apparatus extending a ground plane on an antenna proximate to a dielectric structure, such as a windshield, in order to couple a radiated wave into the dielectric structure in order to control the tilt of the radiation pattern of the antenna.

### BACKGROUND

The present application generally relates to antennas embedded on glass structures. More specifically, the application teaches a surface mount antenna which is mounted to a dense dielectric material, such as a glass windshield in such a way that radiation is steered to a lower elevation angle.

### BACKGROUND INFORMATION

Glass structures are a convenient location to mount antennas and other conductors. Glass structures are nonconductive and facilitate a greater variety of radiation patterns and directivity for designers. Radio frequency (RF) applications used in automobiles had increased over the past few decades to now include AM/FM radio, GNSS, 4G/LTE, satellite radio, remote keyless entry, dedicated short-range communications (DSRC) radio, WiFi, tire pressure monitors, and automotive radars. Although a few RF systems can share an antenna, in general a separate antenna is needed for each RF system. Some RF services will need more than one antenna, such as 4G with at least two MIMO antennas, DSRC which may need multiple antenna diversity, and automotive radar of which multiple are required to cover all sides of a vehicle. The dilemma presented to automotive designers is where to put all of these antennas while maintaining automotive styling.

Window glass is a good RF substrate and cars have a lot of windows. AM and FM antennas on glass have been available for over 20 years, appearing as thin (1 mm) printed wires on the rear or side windows of many vehicles. However, these printed wire antennas are too lossy for the higher frequencies of operation for 4G/LTE (700-3800 MHz), GNSS (1150 MHz-1610 MHz over multiple bands), WiFi and DSRC (2400 MHz-6000 MHz over multiple bands), not to mention automotive radar at 77 GHz. Furthermore, auto glass is often mounted in an off vertical position to account for aerodynamics. When mounted on an angled windshield for example, an antenna with broadside beam would have a radiation pattern with a maximum elevated from horizontal, and a horizontal directivity less than maximum. It would be desirable to overcome these disadvantages while still having an antenna mounted to a glass vehicle surface.

### SUMMARY

Embodiments according to the present disclosure provide a number of advantages. For example, embodiments according to the present disclosure may facilitate radiation patterns with greater directivity in a horizontal direction when an antenna is mounted on a sloped dielectric surface, such as a windshield.

In accordance with an aspect of the present invention, an apparatus comprising an antenna having a radiating element on a first side and a ground plane on a second side and wherein the ground plane extends beyond the radiating element in a first direction, and a dielectric material having a first thickness wherein the first side of the antenna is positioned proximate to the dielectric material.

In accordance with another aspect of the present invention, a vehicular antenna structure comprising a dielectric feature having a first thickness, and an antenna having a radiating element on a first side and a ground plane on a second side and wherein the ground plane extends beyond the radiating element in a first direction and wherein the antenna is first side is affixed to the dielectric feature.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates an exemplary application of the vehicle integrated antenna with enhanced beam steering in an automotive environment according to an embodiment.

FIG. 2 is an exemplary antenna design according to an embodiment.

FIG. 3 is an alternate exemplary antenna design according to an embodiment.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description. For example, the circuitry, transmission lines and antennas of the present invention has particular application for use on a vehicle. However, as will be appreciated by those skilled in the art, the invention may have other applications.

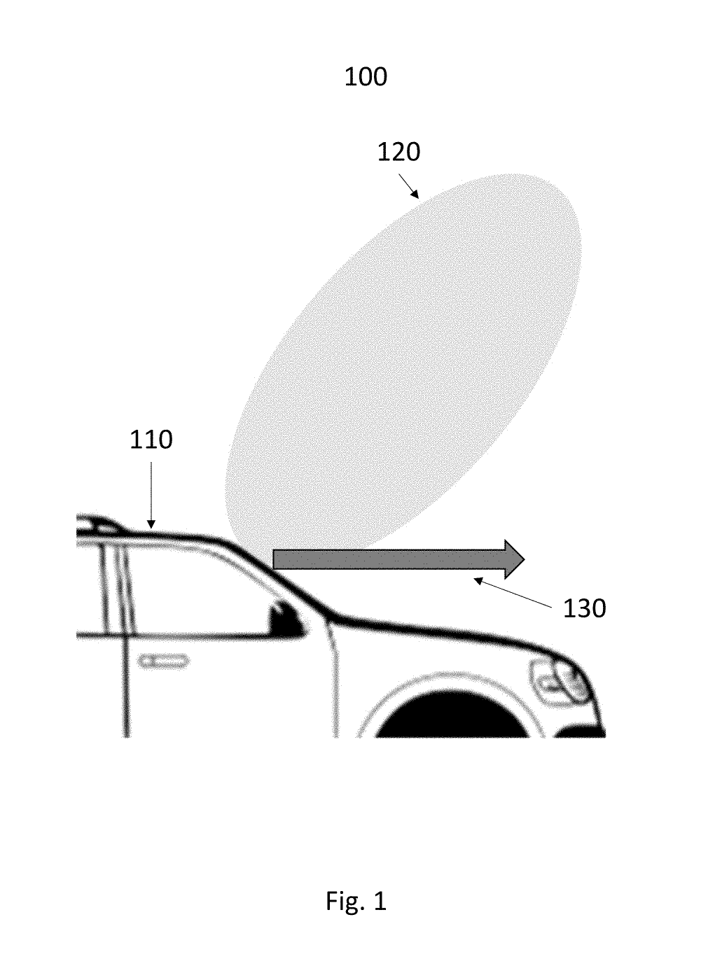

FIG. 1 illustrates an exemplary application of the vehicle integrated antenna with enhanced beam steering in an automotive environment 100. The exemplary application shows a vehicle 110 with windshield, an exemplary radiation pattern 120 of a traditional vertically polarized monopole antenna mounted to a sloped windshield, and an indication of a desired propagation direction 130. When vertically polarized radiation is desired at low elevation angles towards the horizon, the Yagi—or dipole type of antennas having vertically polarized antenna elements could meet the radiation requirement. Due to the size of the ˜λ/2 dipoles and a need for a balun for the dipole based antennas, monopole based alternatives with a ground plane are preferred. However, the finite size ground plane of the antenna limits the beam tilt angle. To achieve a desired additional 10° of beam tilt the ground plane needs to be longer by at least a wavelength. This could potentially make it unsuitable for use in vehicular applications where size and installation space of antennas are of high priority.

An additional beam tilt angle may be achieved by utilizing the electrically thick and denser dielectric passive structure such as the glass or windshield of existing components of the vehicle. The lower beam tilt can be accomplished assisted by the surface waves along the passive structure without increasing the ground plane size of the antenna. Additionally, a narrower beam width in the elevation angle can be obtained without increasing the number of the antenna element in the array since the surface waves act as multiple sources when it radiates slowly while propagating along the passive superstrate structure. When the antenna integrated conformal onto a windshield of the automobile 110, it can achieve the beam tilt up to and below the horizon because of the natural slope of the windshield without occupying much volume in the package space.

The proposed exemplary antennas use an existing vehicle component as integral part of the antennas as to generate desired radiation characteristics and/or enhance the beam steering characteristics. The antennas could be integrated conformal to or offset at a certain distance to an electrically thick and denser dielectric medium (i.e. relative dielectric constant, εᵣ>1) of an existing vehicle components, which includes and not limited to windshield and glass windows. A thickness of an automobile windshield varies around 4 mm to 5 mm which becomes electrically thick as the RF frequency increases and is greater than 0.1 guide-wavelength (λg) at 5.8˜6 GHz (which covers WiFi and DSRC bands). When electromagnetic fields launched either in or near the denser and electrically thick dielectric medium, the some of the fields propagate along the vicinity of the air and the dielectric interface. This surface wave is tightly bounded to the interface until the boundary condition changes or interrupted. The disclosure is about antennas which use the windshield and/or glass as integral part of the antennas by utilizing the surface wave to enhance the antenna's main beam tilt performance when the antennas operate at high frequencies (for example, 5.8 GHz˜6 GHz) at which the windshield or glass is electrically thick. The antennas described in the disclosure is useful especially as a complementary antenna for covering the azimuth field of view (FOV) at low-elevation angles which could not be covered by the main antenna, for example the Sharkfin antenna at the rear center of the roof. By integrating the secondary antenna on to or in proximity to the windshield surface for use as a diversity antenna, a full 360° FOV coverage in the azimuth can be achieved in addition to the main antenna.

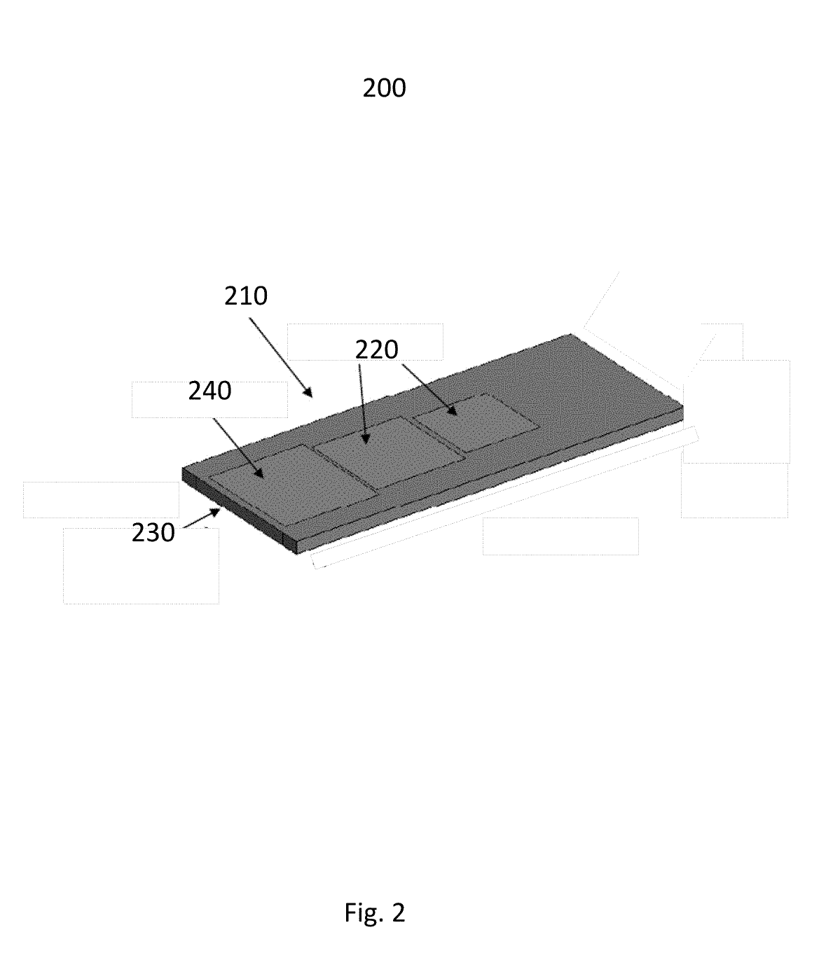

Turning now to FIG. 2, an exemplary antenna design 200 according to the present disclosure is shown. In this exemplary embodiment, the antenna 210 is a coupled patch antenna designed to couple a surface wave to the dielectric medium in order to achieve the desired tilted beam. In this exemplary embodiment, the coupled patch array antenna has a driven patch 240, and two coupled patches 220. The driven patch 240 is fed by a coaxial feed probe (which is not shown), and the reflector 230 printed on the rear edge of the substrate also acts as a tuning stub. In this exemplary embodiment the ground plane of the coupled patch antenna has overall dimensions of approximately 20 mm by 50 mm mounted on the bottom of a 1.2 mm thick dielectric for operation around 5.8 GHz˜6 GHz.

The coupled patch array antenna 210 with a finite size ground plane can provide a limited tilted beam due to the finite length of the ground plane. When the identical antenna is placed as a radiating source conformal to or in close proximity to the electrically thick and denser dielectric medium, for example the windshield or glass, some of the electromagnetic field from the antenna can diffract and some propagate along the air-dielectric interface and then finally radiate with certain phase delays, which could be dependent on the electrical thickness and a propagation constant of the dielectric medium of the superstrate in addition to the distance between the radiating source and the dielectric superstrate medium. The diffracted fields and the surface waves with optimum phased delays are combined to result in an enhanced beam tilt (52°). It is also worth mentioning that the coupled patch array has a plated edge placed at the side end of the substrate close to the driven patch element which acts as a built in frequency tuning mechanism. By reducing the width of the tuning element, the resonant frequency of the antenna increases by decreasing the antenna capacitance. This built in feature is useful to account for uncertainty in RF properties and physical dimensions of the dielectric medium (i.e. glass and windshield).

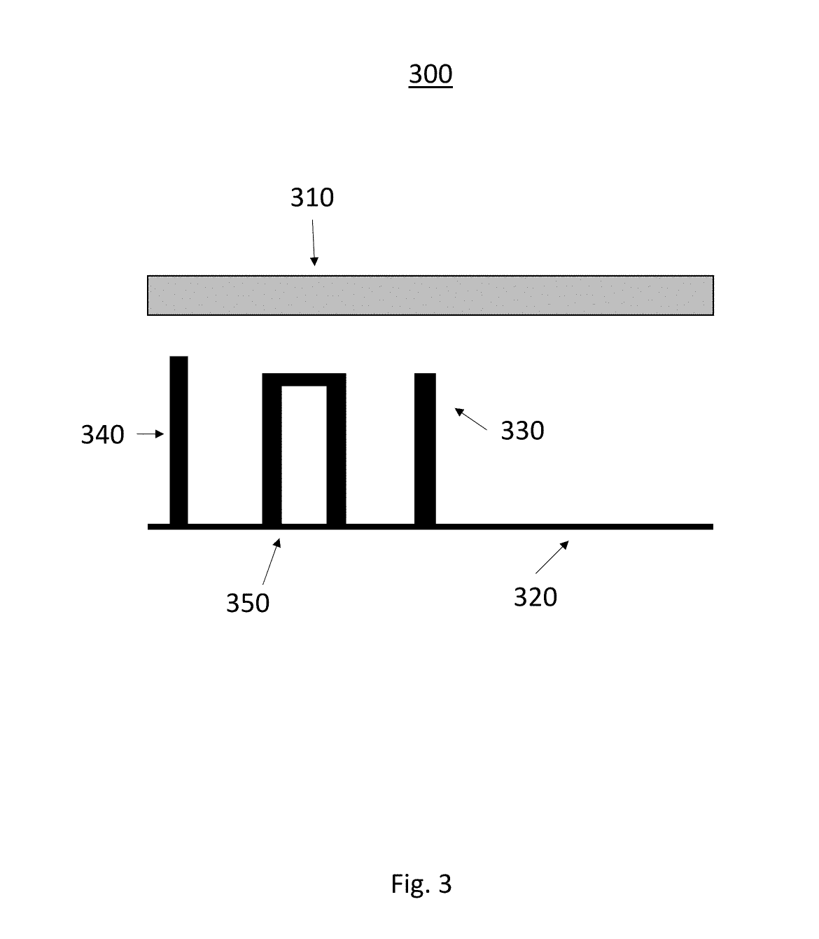

Turning now to FIG. 3, a second exemplary antenna design 300 according to the present disclosure is shown. In this exemplary embodiment a Yagi-Uda monopole array is used having the end-fire radiation characteristics. Although it is the end-fire type of antenna, the Yagi-Uda monopole has a beam tilt limited by the finite size ground plane in addition to the number of director elements. The end-fire type of antenna can also enhance the beam tilt performance. The antenna is shown mounted to a windshield 310. The antenna has a reflector element 340, a radiating element 350 and a director element 330. These elements are mounted to a ground plane 320 which is extended in the desired radiation direction in order to achieve the desired tilt angle.

The radiating source antenna may maintain its relative distance to the surface of the surface wave generating dielectric medium such as a windshield or a glass by integrating the antenna in a bracket or fixture, which can be affixed to the surface of the windshield/glass. The use of an electrically thick and denser dielectric medium as an integral part of antenna helps to generate an enhanced steered beam without using an engineered surface such as the high impedance surface or metamaterial surface. The antenna or array antenna is used as a radiating source to launch surface waves to the dielectric medium in close proximity to the radiating source antenna which combines with the diffracted waves to result in the beam tilt. To control the amount of diffracted and surface waves, the proximity of the radiating source antenna relative to the surface of the dielectric medium may be adjusted. Additionally, the beam tilt may be controlled by optimizing the RF properties and electrical thickness the (i.e. dielectric constant) of the dielectric medium. The use of an existing vehicle components such as the windshield or glass as integral part of the antenna may be used to enhance antenna radiation characteristics.

1. An apparatus comprising:
an antenna having a radiating element on a first side and a ground plane on a second side and wherein the ground plane extends beyond the radiating element in a first direction; and
a dielectric material having a first thickness wherein the first side of the antenna is positioned proximate to the dielectric material.

2. The apparatus of claim 1 wherein the dielectric material is a vehicle windshield.

3. The apparatus of claim 1 wherein the antenna is a coupled patch antenna having a driven patch on the first side and wherein the first side and the second side are separated by a dielectric substrate.

4. The apparatus of claim 1 wherein the antenna is a Uda-Yagi Monopole antenna having a driver element on the first side.

5. The apparatus of claim 1 wherein the ground plane is greater than twice the length of the radiating element.

6. The apparatus of claim 1 wherein the first side and the second side are separated by a dielectric substrate.

7. The apparatus of claim 1 wherein the radiating element and the ground plane are formed on a dielectric substrate.

8. The apparatus of claim 1 wherein the antenna is positioned such that at least one surface wave is coupled to the dielectric material.

9. The apparatus of claim 1 wherein the antenna is positioned such that at least one surface wave is coupled to the dielectric material and wherein the surface wave propagates in a path parallel to the first direction.

10. The apparatus of claim 1 wherein the antenna is excited with a signal and wherein the signal is coupled from the radiating element to the dielectric material such that a surface wave is propagated in the first direction.

11. A vehicular antenna structure comprising:
a dielectric feature having a first thickness; and
an antenna having a radiating element on a first side and a ground plane on a second side and wherein the ground plane extends beyond the radiating element in a first direction and wherein the antenna is first side is affixed to the dielectric feature.

12. The vehicular antenna structure of claim 11 wherein the dielectric feature is a windshield.

13. The vehicular antenna structure of claim 11 wherein the antenna is a coupled patch antenna having a driven patch on the first side and wherein the first side and the second side are separated by a dielectric substrate.

14. The vehicular antenna structure of claim 11 wherein the antenna is a Uda-Yagi Monopole antenna having a driver element on the first side.

15. The vehicular antenna structure of claim 11 wherein the ground plane is greater than twice the length of the radiating element.

16. The vehicular antenna structure of claim 11 wherein the first side and the second side are separated by a dielectric substrate.

17. The vehicular antenna structure of claim 11 wherein the radiating element and the ground plane are formed on a dielectric substrate.

18. The vehicular antenna structure of claim 11 wherein the antenna is positioned such that at least one surface wave is coupled to the dielectric feature.

19. The vehicular antenna structure of claim 11 wherein the antenna is positioned such that at least one surface wave is coupled to the dielectric feature and wherein the surface wave propagates in a path parallel to the first direction.

20. The vehicular antenna structure of claim 11 wherein the antenna is excited with a signal and wherein the signal is coupled from the radiating element to the dielectric feature such that a surface wave is propagated in the first direction.
